(19) United States
(12) Patent Application Publication
(10) Pub. No.: US 2013/0169902 A1
(43) Pub. Date: Jul. 4, 2013

(54) LIQUID CRYSTAL DISPLAY

(71) Applicants: Tetsuya KOJIMA, Nonoichi-shi (JP); Toshiyuki HIGANO, Nonoichi-shi (JP); Daiichi SUZUKI, Nonoichi-shi (JP)

(72) Inventors: Tetsuya KOJIMA, Nonoichi-shi (JP); Toshiyuki HIGANO, Nonoichi-shi (JP); Daiichi SUZUKI, Nonoichi-shi (JP)

(21) Appl. No.: 13/724,425

(22) Filed: Dec. 21, 2012

(30) Foreign Application Priority Data
Dec. 28, 2011 (JP) 2011-287807

(51) Int. Cl. G02F 1/1362

(52) U.S. Cl. CPC G02F 1/136286
USPC 349/43

(57) ABSTRACT

According to one embodiment, a display includes an array substrate including pixel electrodes arranged in a matrix, and alignment film arranged on the pixel electrodes, a countersubstrate provided with counterelectrodes opposed to the pixel electrodes, and an OCB-mode liquid crystal layer held between the array substrate and the countersubstrate. The alignment film and has been subjected to alignment processing in a predetermined direction. Each of the pixel electrodes includes at least one notch defined by continuous edge sides each of which intersects the predetermined direction, and the continuous edge sides include edge sides extending in directions intersecting gate lines and signal lines.

### CROSS-REFERENCE TO RELATED APPLICATIONS

This application is based upon and claims the benefit of priority from Japanese Patent Application No. 2011-287807, filed Dec. 28, 2011, the entire contents of which are incorporated herein by reference.

### FIELD

Embodiments described herein relate generally to a liquid crystal display.

### BACKGROUND

In an optically compensated bend (OCB) mode liquid crystal display, retardation of a liquid crystal layer is changed by forming bend alignment in a liquid crystal material, and changing a tilt angle of liquid crystal molecules in close proximity to each alignment film. The OCB mode is one of display modes in which an excellent response speed and view angle characteristics can be realized.

In the OCB-mode liquid crystal display, it is necessary to form bend alignment in the liquid crystal material as described above. However, in the initial state before turning-on of the power, splay alignment is formed in the liquid crystal material. This is because in the liquid crystal material, the splay alignment is more stable than the bend alignment. Thus, when the OCB-mode liquid crystal display is to be started, processing for inducing transition from splay alignment to bend alignment is necessary.

In order to develop the transition, it is necessary to supply energy of an amount greater than a difference in state energy between the bend alignment and splay alignment to the liquid crystal layer. For example, as a method of inducing transition from the splay alignment to the bend alignment in the liquid crystal material, a method of supplying electrostatic energy to the liquid crystal layer by applying a voltage thereto is proposed.

The transition in the liquid crystal material advances from a transition nucleus and spreads throughout the entire liquid crystal layer. However, in some cases, a transition nucleus has not been generated depending on the direction of alignment processing of an alignment film arranged on pixel electrodes even when the same configuration for forming the transition nucleus is used every time. Accordingly, at present, a highly versatile configuration of a transition nucleus forming part which can be used in common in liquid crystal displays in which the alignment processing directions of the alignment films variously differ from each other with respect to the configuration of the interconnects and electrodes is required.

### BRIEF DESCRIPTION OF THE DRAWINGS

FIG. 1 is a view schematically showing a configuration example of a liquid crystal display of an embodiment.

FIG. 2 is a view for explaining a configuration example of a pixel electrode of the liquid crystal display of the embodiment.

FIG. 3 is a view for explaining an example of a relationship between a transition nucleus forming part and rubbing direction shown in FIG. 2.

FIG. 4 is a view for explaining another example of the relationship between a transition nucleus forming part and rubbing direction shown in FIG. 2.

FIG. 5 is a view for explaining another configuration example of the pixel electrode of the liquid crystal display of the embodiment.

### DETAILED DESCRIPTION

In general, according to one embodiment, a liquid crystal display comprises an array substrate including a plurality of pixel electrodes arranged in a matrix-like form, gate lines extending along rows in which the pixel electrodes are arranged, signal lines extending along columns in which the pixel electrodes are arranged, Pixel switches arranged in the vicinities of positions at which the gate lines and the signal lines intersect each other, and an alignment film which is arranged on the plurality of pixel electrodes, and have been subjected to alignment processing in a predetermined direction; a countersubstrate provided with counterelectrodes opposed to the plurality of pixel electrodes; and an OCB-mode liquid crystal layer held between the array substrate and the countersubstrate. Each of the pixel electrodes includes at least one notch part defined by a plurality of edge sides including continuous edge sides each of which intersects an alignment processing direction of the alignment film, and the plurality of edge sides include edge sides extending in directions intersecting the gate lines and the signal lines.

Hereinafter, an embodiment will be described below with reference to the drawings.

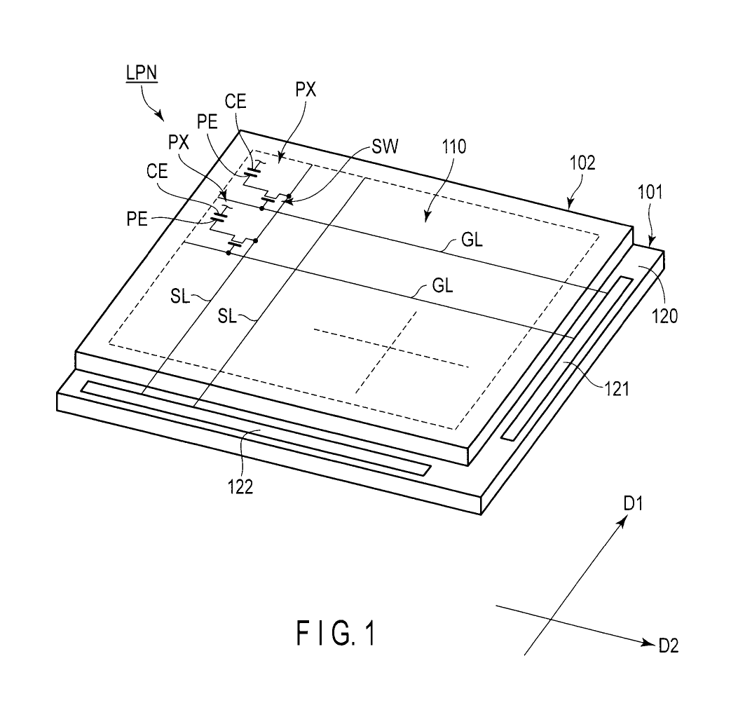

FIG. 1 is a view schematically showing a configuration example of a liquid crystal display of the embodiment. The liquid crystal display according to this embodiment is provided with an OCB-mode liquid crystal display panel LPN including a display section 110 constituted of a plurality of display pixels PX, and illuminating means (not shown) for illuminating the display section 110 of the liquid crystal display panel LPN.

The liquid crystal display panel LPN includes a pair of substrates, i.e., an array substrate AR and countersubstrate CT, and liquid crystal layer LQ held between the array substrate AR and countersubstrate CT.

The array substrate AR includes a transparent insulating substrate such as glass or the like. A pixel electrode PE is arranged on the transparent insulating substrate in each display pixel PX. Furthermore, the array substrate AR includes a plurality of gate lines GL arranged along rows in which a plurality of pixel electrodes PE are arranged, a plurality of signal lines SL extending along columns in which a plurality of pixel electrodes PE are arranged among a plurality of pixel electrodes PE, and a plurality of pixel switches SW arranged in the vicinities of intersection positions of the gate lines GL and signal lines SL.

Each of the pixel switches SW includes, for example, a thin-film transistor (TFT) including a semiconductor layer as a switching element. The gate of a pixel switch SW is electrically connected to a gate line GL (or is formed integral with the gate line GL). The source of the pixel switch SW is electrically connected to a signal line SL (or is formed integral with the signal line SL). The drain of the pixel switch SW is electrically connected to a pixel electrode PE (or is formed integral with the pixel electrode PE). That is, a source-drain path of the pixel switch SW is connected between a signal line SL and pixel electrode PE. When driven through each corresponding gate line GL, each pixel switch SW is made to conduct between the corresponding signal line SL and corresponding pixel electrode PE.

The liquid crystal display panel LPN is provided with a first driver 121 configured to sequentially drive a plurality of gate lines GL in order to bring a plurality of pixel switches SW into conduction in units of, for example, one or more rows, and second driver 122 configured to output a video signal or a non-video signal to each of a plurality of signal lines SL during a period in which a pixel switch SW of each row is in a conductive state by the drive of a corresponding gate line GL. Each of the first driver 121 and second driver 122 is a drive section configured to drive the gate lines GL or the signal lines SL.

There is a case where the first driver 121 and second driver 122 are formed into an IC shape of external circuitry, and case where they are incorporated into the array substrate AR on a part thereof as an internal circuit. In the liquid crystal display according to this embodiment, the first driver 121 and second driver 122 are arranged in a circumference 120 of the display section 110, and are controlled by an externally provided control circuit.

The countersubstrate CT includes a color filter (not shown) constituted of pigmented layers of, for example, red, green, and blue arranged on the transparent insulating substrate such as glass or the like, counterelectrode CE, and the like arranged on the color filter opposite to a plurality of pixel electrodes PE. In the case of the liquid crystal display of a color display type, display pixels PX include a plurality of types of color display pixels to be classified according to colors of pigmented layers arranged in the display pixels PX. A red display pixel includes a red pigmented layer. A green display pixel includes a green pigmented layer. A blue display pixel includes a blue pigmented layer. It should be noted that when the liquid crystal display is not of the color display type, the color filter is omitted.

Each of the pixel electrode PE and counterelectrode CE is constituted of a transparent electrode material such as an ITO or the like, and is covered with a pair of alignment films (not shown) which has been subjected to alignment processing such as rubbing processing, optical alignment processing, and the like in directions parallel to each other. As a material for the alignment film, a resin such as a polyimide or the like can be used. In this embodiment, rubbing processing is employed as the alignment processing of the alignment film.

The pixel electrode PE and the counterelectrode CE constitute a display pixel PX together with a pixel region which is part of a liquid crystal layer LQ controlled to be in liquid crystal molecular arrangement corresponding to electric fields from the pixel electrode PE and counterelectrode CE.

Each of the plurality of display pixels PX includes liquid crystal capacitance (not shown) constituted of a liquid crystal layer LQ held between a pixel electrode PE and counterelectrode CE. The liquid crystal capacitance is determined by a relative dielectric constant of the liquid crystal material, pixel electrode area, and liquid crystal cell gap.

A voltage (hereinafter referred to as a source voltage) applied to a signal line SL by the second driver 122 is applied to a pixel electrode PE of a display pixel PX of a selected row through a corresponding pixel switch SW. A potential difference between the voltage (pixel potential) applied to the pixel electrode PE, and countervoltage Vcom applied to the counterelectrode CE is held in the liquid crystal capacitance.

In a normal display operation, the externally provided control circuit outputs a control signal generated on the basis of a synchronization signal input from an external signal source to the first driver 121, outputs a control signal generated on the basis of a synchronization signal input from the external signal source, and video signal input from the external signal source or inverse transition prevention signal for insertion of black to the second driver 122. Furthermore, the control circuit outputs a countervoltage Vcom to the counterelectrode CE of the countersubstrate CT.

Further, also in the transition drive to be carried out prior to display at the time of startup after turning-on of the power, the control circuit outputs a control signal needed to carry out the transition drive to the first driver 121, and outputs a voltage signal for transition to the second driver 122. Furthermore, the control circuit outputs a voltage signal necessary for carrying out the transition drive to also the counterelectrode CE of the countersubstrate CT.

A start pulse signal, clock signal, and the like used to control an operation of a shift register (not shown) of the first driver 121 are included in the control signal output from the control circuit CTR to the first driver 121.

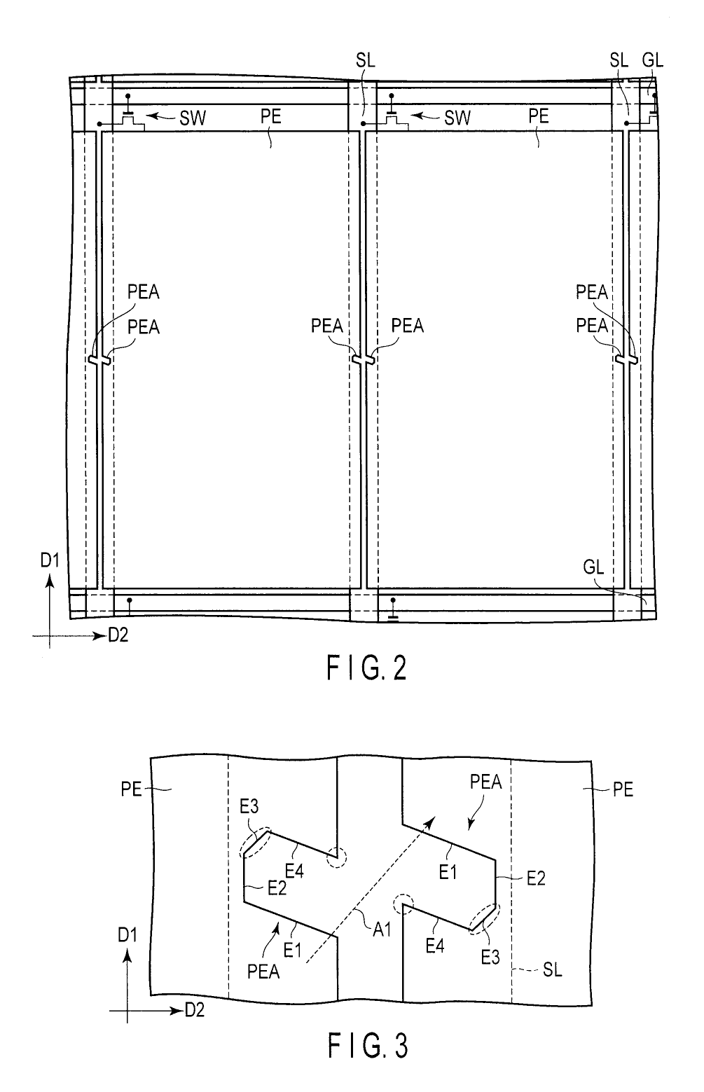

FIG. 2 is a view for explaining a configuration example of a pixel electrode in the liquid crystal display of the embodiment.

The pixel electrode PE includes at least one notch part PEA provided at a central part of an edge side extending along a signal line SL of the pixel electrode PE. In an underlayer of the notch part PEA, the signal line SL is arranged through an insulating layer. Accordingly, in the vicinity of the notch part PEA, it is possible to apply, to the liquid crystal layer LQ, not only a longitudinal voltage resulting from the potential difference between the pixel electrode PE and counterelectrode CE, but also a lateral voltage resulting from the potential difference between the pixel electrode PE and signal line SL.

Notch parts PEA are arranged at positions of pixel electrodes PE arranged side by side in a direction (second direction) D2 in which the gate lines GL extend, the positions being opposed to each other. Notch parts PEA are provided on both of the long sides of the pixel electrode PE, and the notch part PEA on one side being similar image of the notch part PEA on the other side rotated 180°. In other words, the notch part is provided in each long side of the pixel electrode such that, considered as a pair, the two notches exhibit rotational symmetry of the second order.

It should be noted that the positions at which the notch parts PEA are provided are not limited to those shown in FIG. 2. For example, a plurality of notch parts PEA may be provided on one edge side extending along the signal line SL of the pixel electrode PE, and notch parts PEA may be provided on one edge side extending along the gate line GL of the pixel electrode PE. However, the greater the number of the notch parts PEA to be formed in one pixel electrode PE, the more the area of the pixel electrode PE contributing to display is reduced, and hence the number and positions of the notch parts PEA should appropriately be adjusted so that the display quality level can be prevented from being lowered.

FIG. 3 is a view formed by enlarging the opposed notch parts PEA of the adjacent pixel electrodes PE of FIG. 2. Each of the notch parts PEA is defined by edge sides E1 to E4 of the corresponding pixel electrode PE. Edge sides E1 to E4 include edge sides extending in directions intersecting the gate line GL and signal line SL. Each of the pixel electrodes PE includes a first edge side E1 extending from one end part thereof toward the inside of the pixel electrode PE in a direction intersecting a direction (first direction) D1 in which the signal line SL extends and the second direction D2, second edge side E2 extending from the other end part of the first edge side E1 in the first direction D1, fourth edge side E4 extending from one end part thereof toward the inside of the pixel electrode PE in the direction intersecting the first direction D1 and second direction D2, and third edge side E3 connecting between the other end part of the fourth edge side E4 and an end part of the second edge side E2.

In this embodiment, the first edge side E1 and the fourth edge side E4 are substantially parallel to each other, and extend in a direction forming an acute angle with the second direction D2, the acute angle being formed in the clockwise direction from the second direction D2.

A width of the fourth edge side E4 in the second direction D2 is smaller than the width of the first edge side E1 in the second direction D2. Accordingly, the third edge side E3 extends in a direction forming an acute angle with the first direction D1, the acute angle being formed in the clockwise direction from the first direction D1.

Next, transition development of a case where the direction of the rubbing processing of the alignment film is made a direction A1 forming an angle of 45° with the first direction D1, the angle of 45° being formed in the clockwise direction from the first direction D1, when the notch parts PEA are formed in the pixel electrode PE as described above will be investigated.

The alignment film is formed on both the surfaces of the pixel electrode PE, and a foundation layer revealed by removing part of the pixel electrode PE. Accordingly, when an end part of the pixel electrode PE is to be subjected to rubbing processing, there is a case where the rubbing cloth runs onto the pixel electrode PE, and case where the rubbing cloth goes down from the pixel electrode PE to the foundation layer. When the transition drive is carried out by applying a predetermined voltage to the pixel electrode PE, counterelectrode CE, signal line SL, and the like, a transition nucleus becomes more likely to occur in the vicinity of the part of intersection of an edge side onto which the rubbing cloth runs to carry out the rubbing processing, and edge side at which the rubbing cloth goes down to the foundation layer to carry out the rubbing processing.

Here, when the rubbing processing is carried out in a direction A1, in one of the opposed notch parts PEA positioned on the starting end side of direction A1, the rubbing cloth goes down to the foundation layer at each of the first edge side E1 and second edge side E2 to subject edge sides E1 and E2 to the rubbing processing, and the rubbing cloth runs onto the pixel electrode PE at the fourth edge side E4 to subject edge side E4 to the rubbing processing. Further, at each of the edge sides of the pixel electrode PE, the edge sides being provided with the notch part PEA, being connected to the first edge side E1 or the fourth edge side E4, and extending in the first direction D1, the rubbing cloth goes down to the foundation layer to subject each of the edge sides to the rubbing processing. Further, the third edge side E3 is substantially parallel to the rubbing direction A1.

In the other of the opposed notch parts PEA positioned on the terminating end side of direction A1, the rubbing cloth runs onto the pixel electrode PE at each of the first edge side E1 and second edge side E2 to subject edge sides E1 and E2 to the rubbing processing, and the rubbing cloth goes down to the foundation layer at the fourth edge side E4 to subject edge side E4 to the rubbing processing. Further, at each of the edge sides of the pixel electrode PE, the edge sides being provided with the notch part PEA, being connected to the first edge side E1 or the fourth edge side E4, and extending in the first direction D1, the rubbing cloth runs onto the pixel electrode PE to subject each of the edge sides to the rubbing processing. Further, the third edge side E3 is substantially parallel to the rubbing direction A1.

In this case, the part at which the fourth edge side E4, and the edge side of the pixel electrode PE extending in the first direction D1 intersect each other, and the third edge side E3 serve as parts configured to connect the edge side at which the rubbing cloth runs onto the pixel electrode PE, and the edge side at which the rubbing cloth goes down to the foundation layer to each other, and the transition nucleus becomes more likely to occur in the vicinity of each of the parts.

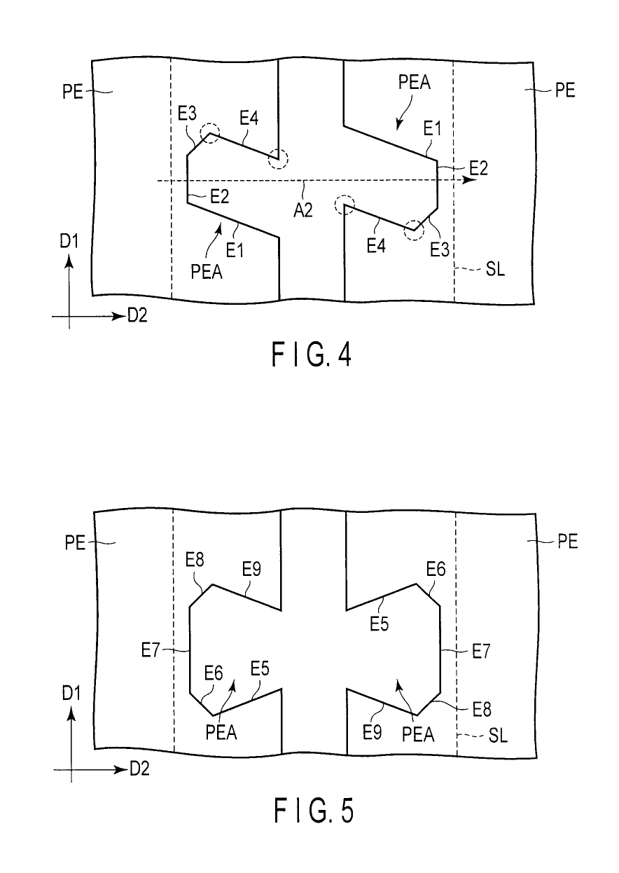

Although FIG. 4 is a view formed by enlarging the opposed notch parts PEA of the adjacent pixel electrodes PE of FIG. 2 in the same manner as FIG. 3, the rubbing processing of the alignment film is carried out in a direction A2 substantially parallel to the second direction D2.

When the rubbing processing is carried out in direction A2, in one of the opposed notch parts PEA positioned on the starting end side of direction A2, the rubbing cloth goes down to the foundation layer at each of the first edge side E1, second edge side E2, and third edge side E3 to subject edge sides E1, E2, and E3 to the rubbing processing, and the rubbing cloth runs onto the pixel electrode PE at the fourth edge side E4 to subject edge side E4 to the rubbing processing. Further, at each of the edge sides of the pixel electrode PE, the edge sides being provided with the notch part PEA, being connected to the first edge side E1 or the fourth edge side E4, and extending in the first direction D1, the rubbing cloth goes down to the foundation layer to subject each of the edge sides to the rubbing processing.

In the other of the opposed notch parts PEA positioned on the terminating end side of direction A2, the rubbing cloth runs onto the pixel electrode PE at each of the first edge side E1, second edge side E2, and third edge side E3 to subject edge sides E1, E2, and E3 to the rubbing processing, and the rubbing cloth goes down to the foundation layer at the fourth edge side E4 to subject edge side E4 to the rubbing processing. Further, at each of the edge sides of the pixel electrode PE, the edge sides being provided with the notch part PEA, being connected to the first edge side E1 or the fourth edge side E4, and extending in the first direction D1, the rubbing cloth runs onto the pixel electrode PE to subject each of the edge sides to the rubbing processing.

In this case, the part at which the fourth edge side E4, and the edge side of the pixel electrode PE extending in the first direction D1 intersect each other, and the third edge side E3 serve as parts configured to connect the edge side at which the rubbing cloth runs onto the pixel electrode PE, and the edge side at which the rubbing cloth goes down to the foundation layer to each other, and a transition nucleus becomes more likely to occur in the vicinity of each of the parts.

That is, when all the continuously connected edge sides of edge sides E1 to E4 forming the notch part PEA of the pixel electrode PE, and edge sides connected to edge side E1 or E4 intersect the rubbing direction A1, a transition nucleus becomes more likely to occur in the vicinity of each of the intersection parts of the successively connected edge sides. It should be noted that in this case, the continuously connected edge sides include edge sides which are made continuous by an edge side substantially parallel to the rubbing direction A1.

As shown in FIG. 3 and FIG. 4, edge sides E1 to E4 defining the notch part PEA of the pixel electrode PE of the liquid crystal display of this embodiment include continuously connected edge sides each of which intersects the rubbing direction even in both the case where the rubbing processing is carried out in the rubbing direction A1, and case where the rubbing processing is carried out in the rubbing direction A2. Accordingly, in the liquid crystal display of this embodiment, even when the alignment film is subjected to the rubbing processing in either direction, a transition nucleus becomes more likely to occur in the vicinity of the notch part PEA, and it becomes possible to smoothly effect the transition of the liquid crystal material.

Further, the notch parts are provided in each long side of the pixel electrode PE such that, considered as a pair, the two notches exhibit rotational symmetry of the second order. Accordingly, it is possible to prevent the transition of the liquid crystal material from becoming one-sided without the transition nuclei becoming more likely to occur only on one side of the second direction D2 of the pixel electrode PE.

Further, the direction in which the transition of the liquid crystal material spreads depends on the alignment processing direction, and the transition spreads from the transition nucleus in a substantially elliptical form (the transition spreads at the highest speed in a direction opposite to the rubbing direction). In this embodiment, the edge side of the pixel electrode PE extending in the first direction D1 is the long side, and the notch part PEA is provided at the central part of the long side, and hence it is possible to develop the transition of the liquid crystal material uniformly and smoothly from the transition nucleus generated in the vicinity of the notch part PEA to the whole display pixel PX.

As described above, according to this embodiment, it is possible to provide a liquid crystal display having high versatility.

It should be noted that in the above embodiment, although the liquid crystal display including the notch parts of the pixel electrode PE as shown in FIG. 3 and FIG. 4 has been described, the shape of the notch part PEA is not limited to the above-mentioned shape. It is sufficient if the pixel electrode PE has continuous edge sides intersecting a plurality of rubbing directions at the notch part PEA and, the notch part PEA may also have a shape defined by edge sides E5 to E9 of the pixel electrode PE as shown in, for example, FIG. 5. In this case, the notch parts are provided on both of the long sides of the pixel electrode PE, and the notch part on one side being mirror image of the notch on the other side.

Edge side E5 extends in a direction shifted counterclockwise from the second direction D2 by an acute angle, and one end of edge side E5 is connected to an edge side extending in the first direction D1. Edge side E9 extends in a direction shifted clockwise from the second direction D2 by an acute angle, and one end of edge side E9 is connected to an edge side extending in the first direction D1. Edge side E7 extends substantially in parallel with the first direction D1. Edge side E6 extends in a direction shifted counterclockwise from the first direction D1 by an acute angle, and connects the other end of edge side E5, and one end of edge side E7 to each other. Edge side E8 extends in a direction shifted clockwise from the first direction D1 by an acute angle, and connects the other end of edge side E7, and the other end of edge side E9 to each other.

Even in the case of the shape of the notch part PEA, the pixel electrode PE includes, at the notch part PEA, continuous edge sides intersecting a plurality of rubbing directions, for example, directions A1 and A2, and an advantage identical to the above-mentioned embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the configuration example of the above-mentioned embodiment, although a signal line is arranged in the underlayer of the notch part PEA, a configuration in which a supplementary capacitance line is arranged in the underlayer in place of the signal line may also be employed. Even in that case, an advantage identical to the above-mentioned embodiment can be obtained.

What is claimed is:

1. A liquid crystal display comprising:
an array substrate including a plurality of pixel electrodes arranged in a matrix-like form, gate lines extending along rows in which the pixel electrodes are arranged, signal lines extending along columns in which the pixel electrodes are arranged, pixel switches arranged in the vicinities of positions at which the gate lines and the signal lines intersect each other, and an alignment film which is arranged on the plurality of pixel electrodes, and has been subjected to alignment processing in a predetermined direction;
a countersubstrate including a counterelectrode opposed to the plurality of pixel electrodes; and
an OCB-mode liquid crystal layer held between the array substrate and the countersubstrate, wherein
each of the pixel electrodes includes at least one notch part defined by a plurality of edge sides including continuous edge sides each of which intersects an alignment processing direction of the alignment film, and
the plurality of edge sides include edge sides extending in directions intersecting the gate lines and the signal lines.

2. The liquid crystal display according to claim 1, wherein the signal line is arranged in an underlayer of the notch part.

3. The liquid crystal display according to claim 1, wherein the notch part is provided at a central part of a long side of the pixel electrode.

4. The liquid crystal display according to claim 2, wherein the notch part is provided at a central part of a long side of the pixel electrode.

5. The liquid crystal display according to claim 3, wherein the notch part is provided in each long side of the pixel electrode such that, considered as a pair, the two notches exhibit rotational symmetry of the second order.

6. The liquid crystal display according to claim 4, wherein the notch part is provided in each long side of the pixel electrode such that, considered as a pair, the two notches exhibit rotational symmetry of the second order.

7. The liquid crystal display according to claim 1, wherein the plurality of edge sides include a first edge side extending toward the inside of the pixel electrode in a direction intersecting a first direction in which the signal line extends and a second direction in which the gate line extends, a second edge side extending from an end part of the first edge side in the first direction, a fourth edge side extending toward the inside of the pixel electrode in the direction intersecting the first direction and the second direction, and a third edge side connecting between an end part of the fourth edge side and an end part of the second edge side.

8. The liquid crystal display according to claim 2, wherein the plurality of edge sides include a first edge side extending toward the inside of the pixel electrode in a direction intersecting a first direction in which the signal line extends and a second direction in which the gate line extends, a second edge side extending from an end part of the first edge side in the first direction, a fourth edge side extending toward the inside of the pixel electrode in the direction intersecting the first direction and the second direction, and a third edge side connecting between an end part of the fourth edge side and an end part of the second edge side.

9. The liquid crystal display according to claim 3, wherein the plurality of edge sides include a first edge side extending toward the inside of the pixel electrode in a direction intersecting a first direction in which the signal line extends and a second direction in which the gate line extends, a second edge side extending from an end part of the first edge side in the first direction, a fourth edge side extending toward the inside of the pixel electrode in the direction intersecting the first direction and the second direction, and a third edge side connecting between an end part of the fourth edge side and an end part of the second edge side.

10. The liquid crystal display according to claim 4, wherein the plurality of edge sides include a first edge side extending toward the inside of the pixel electrode in a direction intersecting a first direction in which the signal line extends and a second direction in which the gate line extends, a second edge side extending from an end part of the first edge side in the first direction, a fourth edge side extending toward the inside of the pixel electrode in the direction intersecting the first direction and the second direction, and a third edge side connecting between an end part of the fourth edge side and an end part of the second edge side.

11. The liquid crystal display according to claim 5, wherein the plurality of edge sides include a first edge side extending toward the inside of the pixel electrode in a direction intersecting a first direction in which the signal line extends and a second direction in which the gate line extends, a second edge side extending from an end part of the first edge side in the first direction, a fourth edge side extending toward the inside of the pixel electrode in the direction intersecting the first direction and the second direction, and a third edge side connecting between an end part of the fourth edge side and an end part of the second edge side.

12. The liquid crystal display according to claim 6, wherein the plurality of edge sides include a first edge side extending toward the inside of the pixel electrode in a direction intersecting a first direction in which the signal line extends and a second direction in which the gate line extends, a second edge side extending from an end part of the first edge side in the first direction, a fourth edge side extending toward the inside of the pixel electrode in the direction intersecting the first direction and the second direction, and a third edge side connecting between an end part of the fourth edge side and an end part of the second edge side.
